(19) United States
(12) Patent Application Publication
(10) Pub. No.: US 2020/0271198 A1
(43) Pub. Date: Aug. 27, 2020

(54) GEAR SHIFTING DEVICE FOR A TRANSMISSION

(71) Applicant: AVL COMMERCIAL DRIVELINE & TRACTOR ENGINEERING GMBH, STEYR (AT)

(72) Inventor: Burkhart Breinesberger, Linz (AT)

(21) Appl. No.: 16/762,823

(22) PCT Filed: Nov. 9, 2018
(86) PCT No.: PCT/AT2018/060267

§ 371 Date: May 8, 2020

(30) Foreign Application Priority Data
Nov. 10, 2017 (AT) A 50942/2017

(51) Int. Cl. F16H 3/66; F16D 23/06; F16D 23/14; F16H 3/78

(52) U.S. Cl. CPC F16H 3/663; F16D 23/06; F16D 23/14; F16H 2200/2043; F16H 2200/0043; F16H 2200/2005; F16H 2200/2023; F16H 3/78

(57) ABSTRACT

Various aspects of the present disclosure are directed to a gear shifting device for a transmission. In some embodiments, the gear shifting device includes at least one rotatably mounted transmission element and at least one transmission element fixed to a housing, and including at least one braking device for holding the at least one rotatably mounted transmission element. The braking device has a sliding sleeve connected to the at least one transmission element of the transmission in an axially displaceable manner. In a first switched position of the sliding sleeve, a rotatably mounted first transmission element is connected non-rotatably to the transmission element fixed to the housing and. In a second switched position of the sliding sleeve, the rotatably mounted first transmission element is separated from the transmission element fixed to the housing. The braking device including at least a first and/or second synchronizer ring.

The invention relates to a gear shifting device for a transmission, in particular for a planetary transmission having at least one rotatably mounted transmission element and at least one transmission element which is fixed to the housing, having at least one braking device for holding the at least one rotatably mounted transmission element, wherein the braking device has a sliding sleeve which is connected in a rotationally fixed manner but—with respect to an axis of rotation of the at least one rotatably mounted transmission element—in an axially displaceable manner to a transmission element of the transmission, and wherein, in a first shift position of the sliding sleeve, a rotatably mounted first transmission element is connected in a rotationally fixed manner to the transmission element which is fixed to the housing and, in a second shift position of the sliding sleeve, the rotatably mounted first transmission element is separated from the transmission element which is fixed to the housing.

From DE 10 2014 205 550 A1, a transmission system with a planetary transmission designed as a Ravigneaux planetary gear set is known, which comprises a small sun gear, a large sun gear, a planet carrier with a first planet gear set and a second planet gear set, as well as a ring gear, wherein the small sun gear is in meshing engagement with the first planet gears of the first planet gear set, the first planet gears with second planet gears of the second planet gear set, and the second planet gears are in meshing engagement with the large sun gear and the ring gear. The large sun gear can be held by a first brake and the planet carrier by a second brake.

Other transmission systems with Ravigneaux planetary transmissions are known from DE 10 2013 016 441 A1 or DE 10 2012 106 690 A1.

With a Ravigneaux planetary transmission, several shift positions can be achieved by means of brakes or clutches fixed to the housing. It is known to use relatively cost-intensive multi-disc clutches or multi-disc brakes for these gear changes.

U.S. Pat. No. 2,582,487 A describes a transmission arrangement with a planetary transmission, wherein either a rotatably mounted first transmission element or a rotatably mounted second transmission element can be held via a sliding sleeve, i.e. connected to a transmission element fixed to the housing. The sliding sleeve is axially displaceable on its outer jacket and is guided in the transmission housing in a rotationally fixed manner. A synchronizing device is not provided, which is why the transmission arrangement is particularly suitable for standstill gear changes.

The printed publications DE 198 06 031 A1 and EP 0 086 875 A1 disclose synchronizing devices with gear shifting devices in which a first shaft can be connected to a second or third shaft by means of a sliding sleeve.

The printed publications DE 1 211 077 A, DE 20 2016 102 495 U1, DE 103 48 755 A1, WO 2009/140840 A1, U.S. Pat. No. 4,294,338 A show a synchronizing device with gear shifting devices, in which a first shaft can be connected to a second shaft or a housing by means of a sliding sleeve.

It is the object of the invention to enable at least two shift positions in a planetary transmission of the type mentioned above to be achieved with the least possible effort and in a compact manner.

According to the invention, this is achieved in that the braking device has at least one first synchronizer ring which cooperates via a first friction surface with a corresponding first mating surface of a first clutch body which is connected in a rotationally fixed manner to the rotatably mounted first transmission element or the transmission element fixed to the housing, and/or the braking device has at least one second synchronizer ring which cooperates via a second friction surface with a corresponding second mating surface of a second clutch body which is connected in a rotationally fixed manner to the rotatably mounted second transmission element, wherein a synchronizer body which is connected in a rotationally fixed manner to the housing via the sliding sleeve is arranged adjacent to at least one clutch body.

Transmissions are generally understood here to be machine elements with which torque, speed and/or direction of rotation can be changed between an input and an output.

A transmission element is understood here to be an element of the transmission which is necessary to change torque, speed and/or direction of rotation between an input and an output. This includes both rotating elements—for example coupling partners of shafts or, in the case of a planetary transmission, for example sun gear, planet carrier and ring gear—and also elements fixed to the housing, which exert reaction forces on a rotating element when it is braked or held in place.

The transmission element fixed to the housing is either attached to the housing of the transmission or is formed in one piece with it.

The fact that a rotatably mounted transmission element is separated from the transmission element fixed to the housing means, according to the invention, that the rotatably mounted transmission element is rotatable relative to the housing.

The synchronizer body is designed to rotate relative to the first and/or second transmission element. It is preferably provided that the synchronizer body is rotatably mounted on the rotatably mounted first or the rotatably mounted second transmission element.

With the sliding sleeve it is easy to switch between a first shift position and a second shift position, wherein in the first shift position the rotatably mounted first transmission element is braked or held in place.

A first embodiment variant of the invention according to the invention provides that in the first shift position a rotatably mounted second transmission element is separated from the housing and in the second shift position the second transmission element is connected in a rotationally fixed manner to the transmission element fixed to the housing. The sliding sleeve is thereby connected to the transmission element fixed to the housing in a rotationally fixed but—with respect to an axis of rotation of at least one rotatably mounted transmission element—axially displaceable manner. In the first shift position of the sliding sleeve, the rotatably mounted first transmission element is connected in a rotationally fixed manner to the transmission element fixed to the housing and the rotatably mounted second transmission element is separated from the housing. In the second shift position of the sliding sleeve, the rotatably mounted first transmission element is separated from the transmission element fixed to the housing and the rotatably mounted second transmission element is connected in a rotationally fixed manner to the transmission element fixed to the housing.

An embodiment variant of the invention provides that between the first and the second shift position of the sliding sleeve a neutral position is formed in which neither the rotatably mounted first nor the rotatably mounted second transmission element is braked or held. In the neutral position, the rotatably mounted first transmission element and the rotatably mounted second transmission element are thus completely separated from the housing.

In a particularly advantageous embodiment variant of the invention, it is provided that the sliding sleeve is rotationally connectable via at least one synchronizer ring to the rotatably mounted first transmission element or the rotatably mounted second transmission element and the transmission element fixed to the housing. The synchronizer ring allows, in a simple manner and with minimum installation space, the rotatably mounted first transmission element or the rotatably mounted second transmission element of the transmission element to be braked or held.

It is provided in a further embodiment of the invention that on a side of the first synchronizer ring facing away from the first clutch body and adjacent thereto and/or on a side of the second synchronizer ring facing away from the second clutch body and adjacent thereto the synchronizer body which is connected to the housing via the sliding sleeve is arranged.

The synchronizer body prevents the sliding sleeve from shifting as long as the speed of the clutch body and the sliding sleeve is not synchronized, i.e. as long as the clutch body is not stationary. The synchronizer body is advantageously arranged between the first and second clutch bodies and is preferably mounted rotatably on the rotatably mounted first transmission element.

Via the conical friction surfaces of the synchronizer rings and the clutch bodies, the speed of the rotatably mounted first or second transmission element is reduced. As soon as the corresponding clutch body comes to a standstill, the sliding sleeve is further axially displaced via the synchronizer ring and clutch body, wherein an internal toothing of the sliding sleeve engages in external toothing of the synchronizer ring and the clutch body.

In a constructionally simple embodiment of the invention, it is provided that the second clutch body is rotatably mounted on the first transmission element or on the transmission element fixed to the housing.

A particularly compact and easily mountable design can be achieved if the braking device and the transmission are designed as a unit, wherein preferably the braking device is integrated into the planetary set.

The transmission can, for example, be a planetary transmission with at least one rotatably mounted first transmission element, at least one rotatably mounted second transmission element and at least one third transmission element from the group sun gear, planet carrier and ring gear.

In a preferred embodiment variant of the invention, it is provided that the planetary transmission is designed as a Ravigneaux planetary transmission with a first sun gear, a second sun gear, a planet carrier with a first planet gear set comprising first planet gears and a second planet gear set comprising second planet gears, and a ring gear, wherein the first sun gear is in meshing engagement with the first planet gears, the first planet gears with second planet gears, and the second planet gears are in meshing engagement with the second sun gear and the ring gear. The second sun gear may have a larger diameter than the first sun gear.

A compact and simple design of the braking device is particularly advantageous for Ravigneaux planetary gear sets, so that the planetary transmission can be used without functional restrictions even in the case of severe space limitations.

Particularly compact solutions with high functionality can be achieved if the rotatably mounted first transmission element is formed by a sun gear—preferably the second sun gear—and the rotatably mounted second transmission element by a planet carrier.

In this way, a 2-speed transmission with mechanical synchronization and without cost-intensive multi-disc brakes can be realized particularly easily.

The invention is explained in more detail in the following in the embodiment example shown in the non-restrictive figures, which show schematically:

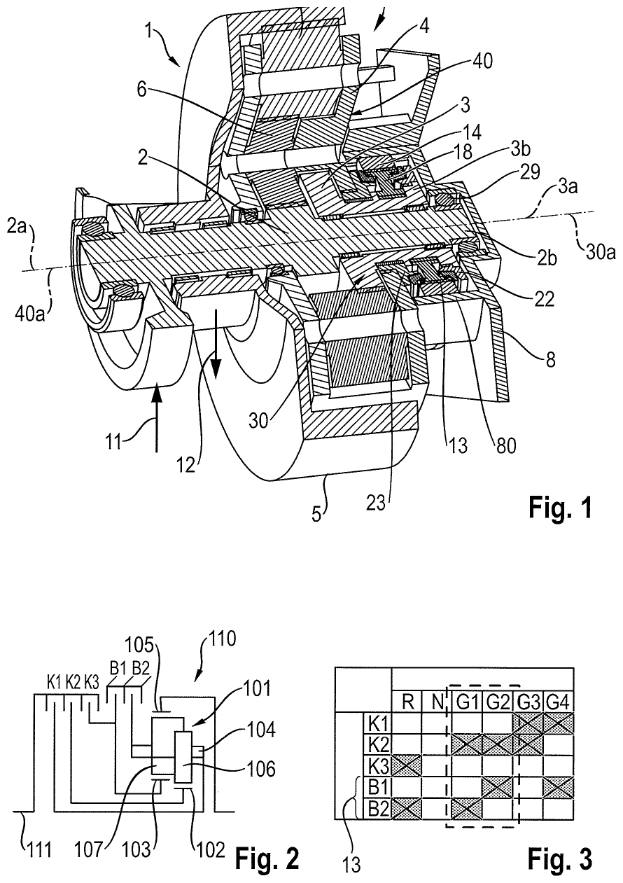

FIG. 1 shows a planetary transmission with a gear shifting device according to the invention in a first embodiment variant in an oblique view;

FIG. 2 shows a transmission diagram for a known transmission arrangement;

FIG. 3 shows a shift logic of this transmission arrangement;

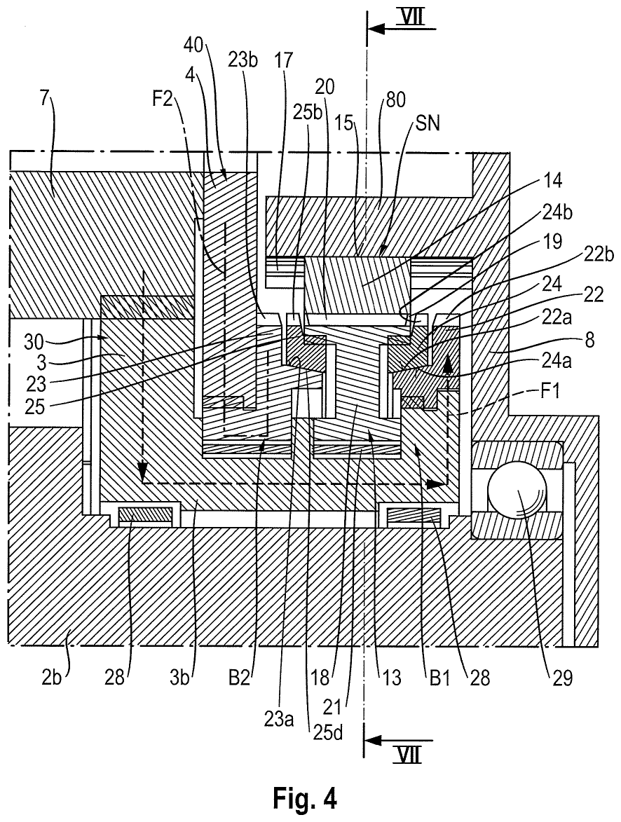

FIG. 4 shows the planetary transmission from FIG. 1 in a detailed view of the shifting element device according to the invention;

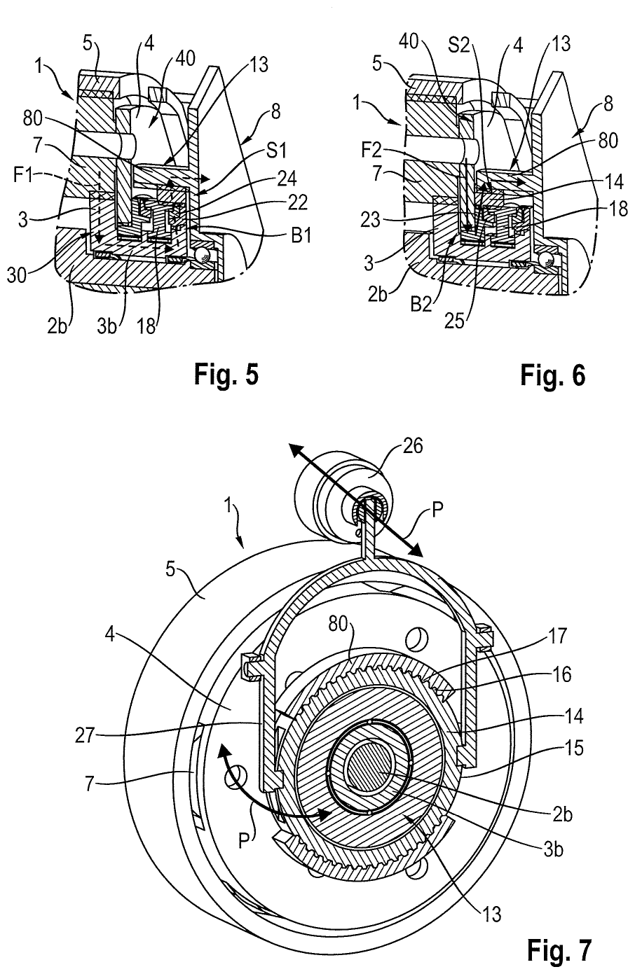

FIG. 5 shows the gear shifting device of the planetary transmission in a first shift position;

FIG. 6 shows the gear shifting device of the planetary transmission in a second shift position;

FIG. 7 shows the planetary transmission in a section according to line VII-VII in FIG. 4 in an oblique view;

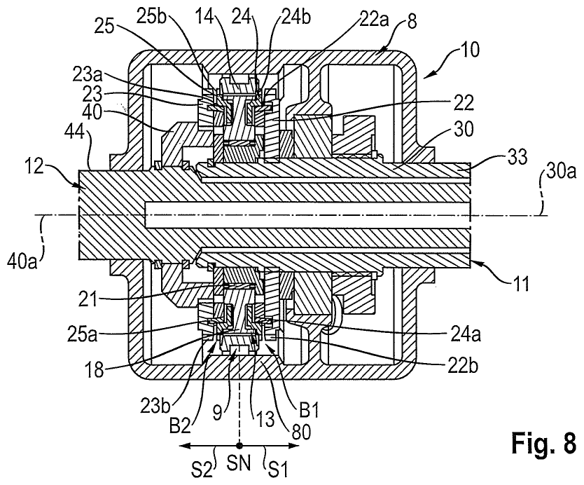

FIG. 8 shows a gear shifting device according to the invention in a second embodiment variant in a longitudinal section; and

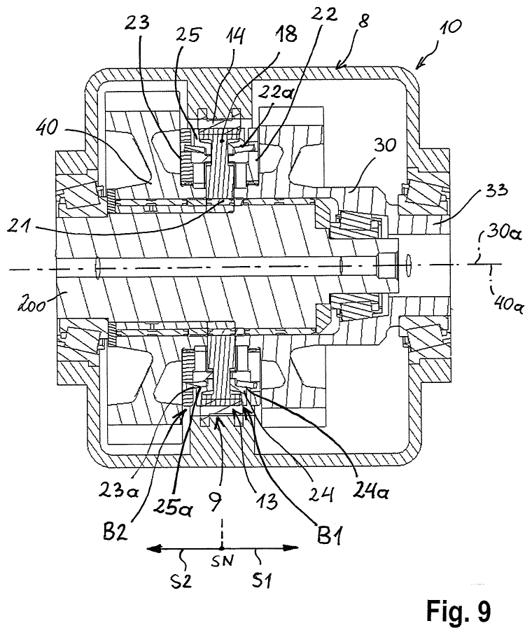

FIG. 9 shows a gear shifting device according to the invention in a third embodiment variant in a longitudinal section.

FIG. 1 shows a transmission arrangement 10 with a planetary transmission 1 designed as Ravigneaux planetary transmission, which has the transmission elements of first sun gear 2, second sun gear 3, planet carrier 4 and ring gear 5.

The planet carrier 4 has a first planet gear set with first planet gears 6 and second planet gear set with second planet gears 7.

The first sun gear 2, which is connected to a drive 11 in a rotationally fixed manner, is in meshing engagement with the first planet gears 6. The first planet gears 6 are in meshing engagement with the second planet gears 7, and the second planet gears 7 are in meshing engagement with the second sun gear 3 and the ring gear 5. The ring gear 5 is connected to an output 12. Reference numeral 8 designates a fixed housing, and reference numeral 80 designates a transmission element which is fixed to the housing, which can, for example, be formed in one piece with the housing. At least one rotatably mounted transmission element 30, 40 can be braked or held in place via the transmission element 80 which is fixed to the housing.

The second sun gear 3 is also referred to here as rotatably mounted first transmission element 30 and the planet carrier 4 as rotatably mounted second transmission element 40. The second sun gear 3 has a larger diameter than the first sun gear 2. The planet gears 6, 7 of the planetary transmission 1 are rotatably mounted about axes parallel to the axes of rotation 2a, 3a of the first sun gear 2 and the second sun gear 3 and the axes of rotation 30a, 40a of the rotatably mounted first transmission element 30 and the rotatably mounted second transmission element 40 respectively.

FIG. 2 schematically shows a transmission diagram for a known transmission arrangement 110 with a planetary transmission 101 forming a Ravigneaux planetary transmission, the transmission elements of which can be shifted via clutch devices K1, K2, K3 and brakes B1, B2 of a braking device 13. Reference numerals 102 and 103 designate the sun gears, reference numerals 106, 107 designate the planet gears and reference numeral 105 designates the ring gear connected to output 112. Via the first clutch device K1 the drive 111 can be drive-connected to the planet carrier 104, via the clutch device K2 to the first sun gear 102 and via the clutch device K3 to the second sun gear 103. The second sun gear 103 can be held by the first brake B1 and the planet carrier 104 can be held by the second brake B2. With this transmission arrangement 110 four forward gears G1, G2, G3, G4, one reverse gear R and one neutral gear N can be realized as shown in FIG. 3. The “X” in FIG. 3 indicates closed positions of the clutch devices K1, K2, K3 and the brakes B1, B2. With conventional transmission arrangements 110 the brakes B1 and B2 are usually formed by cost-intensive external multi-disc brakes.

In FIG. 3, the first G1 and second gears G2 are highlighted with dashed lines, which—with a rigid connection of the first sun gear 2, 102 with output drive 12 112—can be shifted with different shift positions of the brakes B1 and B2 alone. A second clutch device K2 is therefore not required for these gears G1 and G2.

With respect to the planetary transmission 1 according to the invention shown in FIG. 1 and FIG. 4 to FIG. 6, the brakes B1, B2 of the braking device 13 are designed with synchronizer rings 24, 25. A sliding sleeve 14 is provided, which is connected to the housing 8 of the planetary transmission 1 in a rotationally fixed but axially displaceable manner in relation to the axis of rotation 3a of the second sun gear 3. In a first shift position S1 of the sliding sleeve 14, formed for example by a first end position, a rotatably mounted first transmission element 30—in this case the second sun gear 3—is connected in a rotationally fixed manner to the housing 8 and a rotatably mounted second transmission element 40—in this case the planet carrier 4—is separated from the housing 8. In a second shift position S2 of the sliding sleeve 14, formed for example by a second end position, the rotatably mounted first transmission element 30—in this case the second sun gear 3—is separated from the housing 8 and the rotatably mounted second transmission element 40—in this case the planet carrier 4—is connected in a rotationally fixed manner to the housing 8.

In the area of its outer jacket 15, the sliding sleeve 14 has at least in sections an external toothing 16 which engages in a corresponding internal toothing 17 of the housing 8 and can be displaced axially—i.e. parallel to the axes of rotation 30a, 40a of the first and second transmission element 30, 40. Inside the sliding sleeve 14 there is a substantially annular synchronizer body 18 which is connected in a rotationally fixed manner via an external toothing 19 to an internal toothing 20 of the sliding sleeve 14. The synchronizer body 18 is rotatably mounted on the second sun gear shaft 3b of the second sun gear 3 via a bearing 21 and is arranged between a first clutch body 22 and a second clutch body 23. The second sun gear shaft 3b is rotatably mounted on the first sun gear shaft 2b via bearing 28, the first sun gear shaft 2b is mounted in the housing 8 via bearing 29. The first clutch body 22 is connected in a rotationally fixed manner to the sun gear shaft 3b of the second sun gear 3. The second clutch body 23 is connected in a rotationally fixed manner to the planet carrier 4.

Between the first clutch body 22 and the synchronizer body 18 a first synchronizer ring 24 is rotatably arranged, between the second clutch body 23 and the synchronizer body 18 a second synchronizer ring 25 is rotatably arranged. Each first 24 or second synchronizer ring 25 has on its inner side a conically shaped first friction surface 24a or second friction surface 25a which interacts with a correspondingly conically shaped outer mating surface 22a, 23a of the first 22 or second clutch body 23.

Similar to a conventional synchronizing device, the sliding sleeve 14 can only be pushed into its respective first S1 or second shift position S2 after synchronizing the corresponding synchronizer ring 24, 25 and the corresponding clutch body 22, 23 via the corresponding external toothings 24b, 25b of the first 24 or second synchronizer ring 25 and via the external toothings 22b, 23b of the first or second clutch body 22, 23.

In FIG. 4, the sliding sleeve 14 is located in its neutral position SN centrally between the two synchronizer rings 24, 25. The dashed lines indicate the force flow F1 between the second sun gear 3 and the first clutch body 23 and dash-dotted lines indicate the force flow F2 between the planet carrier 4 and the second clutch body 23.

FIG. 5 shows the planetary transmission 1 in a first shift position S1 of the sliding sleeve 14, wherein the synchronization between the first synchronizer ring 24 and the first clutch body 22 is completed. The power flow F1 between the second sun gear 3 and the housing 8 running via the sliding sleeve 14 is shown by dashed lines. The second sun gear 3 is braked, thus the second gear G2 is engaged. The parts of sliding sleeve 14, synchronizer body 18, first synchronizer ring 24 and first clutch body 22 thus form the function of the first brake B1 of the braking device 13.

FIG. 6 shows the planetary transmission 1 in a second shift position S2 of the sliding sleeve 14, wherein the synchronization between the second synchronizer ring 25 and the second clutch body 23 is completed. The power flow F2 between the planet carrier 4 and the housing 8 running via the sliding sleeve 14 is indicated by arrows. The planet carrier 4 is thus braked and first gear G1 is engaged. The parts of sliding sleeve 14, synchronizer body 18, second synchronizer ring 25 and second clutch body 23 thus form the function of the second brake B2 of the braking device 13.

As shown in FIG. 7, the sliding sleeve 14 is shifted, for example, by an actuator 26 via a pivotally mounted shift fork 27, which acts on both sides of the circumference of the sliding sleeve 14 on its outer jacket 15 and thus shifts it axially according to the arrows P.

As a result of the described arrangement with a sliding sleeve connected to the housing in a rotationally fixed manner, the torque of the first or second transmission element can be diverted for the gears G1 and G2 by means of the sliding sleeve of the synchronizer unit to a component fixed to the housing without being hindered by rotating components. This enables a very compact and cost-effective design.

FIG. 8 shows a gear shifting device 9 for a transmission 10, which has a first transmission element 30 and a second transmission element 40. By means of a braking device 13 having brakes B1, B2 of a gear shifting device 9 according to the invention, either the first transmission element 30 or the second transmission element 40 can be braked or held in place. The gear shifting device 9 has a sliding sleeve 14 which is connected to the housing 8 of the transmission 10 in a rotationally fixed but axially displaceable manner with respect to the axis of rotation 30a or 40a of the rotatably mounted first transmission element 30 or the rotatably mounted second transmission element 40.

The brakes B1, B2 of the braking device 13 of the gear shifting device 9 are also here designed with synchronizer rings 24, 25. In a first shift position S1 of the sliding sleeve 14 formed, for example, by a first end position, the rotatably mounted first transmission element 30—in the present case a hollow shaft 33—is connected in a rotationally fixed manner to the housing 8 and the rotatably mounted second transmission element 40—in the present case a shaft 44—is separated from the housing 8. In a second shift position S2 of the sliding sleeve 14, formed for example by a second end position, the rotatably mounted first transmission element 30—in this case a hollow shaft 33—is separated from the housing 8 and the rotatably mounted second transmission element 40—in this case a shaft 44—is connected in a rotationally fixed manner to the housing 8.

The design of the gear shifting device 9 is analogous to the first embodiment variant shown in FIG. 1 and FIG. 4 to FIG. 7. Inside the sliding sleeve 14 there is an essentially annular synchronizer body 18 which is connected to the sliding sleeve 14—via a toothing not shown in FIG. 8—in a rotationally fixed but displaceable manner. The synchronizer body 18 is rotatably mounted on the hollow shaft 33 via a bearing 21 and is arranged between a first clutch body 22 and a second clutch body 23. The hollow shaft 33 is rotatably mounted relative to the shaft 44 via bearings not shown in FIG. 8. The hollow shaft 33 and the shaft 44 are rotatably mounted in relation to the housing 8. The first clutch body 22 is connected in a rotationally fixed manner to the hollow shaft 33. The second clutch body 23 is connected in a rotationally fixed manner to the shaft 44.

Between the first clutch body 22 and the synchronizer body 18 a first synchronizer ring 24 is rotatably arranged, between the second clutch body 23 and the synchronizer body 18 a second synchronizer ring 25 is rotatably arranged. Each first 24 or second synchronizer ring 25 has on its inner side a conically shaped first friction surface 24a or second friction surface 25a which interacts with a correspondingly conically shaped outer mating surface 22a, 23a of the first 22 or second clutch body 23.

Similar to a conventional synchronizing device, the sliding sleeve 14 can only be pushed into its respective first S1 or second shift position S2 after synchronizing the corresponding synchronizer ring 24, 25 and the corresponding clutch body 22, 23 via the corresponding external toothings 24b, 25b of the first 24 or second synchronizer ring 25 and via the external toothings 22b, 23b of the first or second clutch body 22, 23.

In FIG. 8 the sliding sleeve 14 is located in its neutral position SN centrally between the two synchronizer rings 24, 25.

FIG. 9 shows a further embodiment variant of a transmission 10, which differs from the embodiment example shown in FIG. 8 in that the shifted transmission elements 30, 40, as well as the synchronizer body 18 are mounted neither on a shaft connected to the first transmission element nor on a shaft connected to the second transmission element in a rotationally fixed manner, and therefore there is no power flow to this separate shaft. In the embodiment example, the transmission elements 30, 40 and the synchronizer body 18 are mounted on a separate shaft, for example on a shaft 200.

1. A gear shifting device for a transmission comprising:
a housing;
at least one rotatably mounted transmission element; and
at least one transmission element fixed to the housing, the at least one transmission element including at least one braking device holding the at least one rotatably mounted transmission element;
wherein the at least one braking device has a sliding sleeve (14) which is connected in a rotationally fixed manner with respect to an axis of rotation (30a, 40a) of the at least one rotatably mounted transmission element, and in an axially displaceable manner to the at least one transmission element or the at least one rotatably mounted transmission element;
wherein, in a first shift position of the sliding sleeve a rotatably mounted first transmission element of the at least one rotatably mounted transmission element is connected in a rotationally fixed manner to the at least one transmission element which is fixed to the housing, and in a second shift position of the sliding sleeve the rotatably mounted first transmission element is separated from the transmission element which is fixed to the housing, characterized in that the at least one braking device includes at least one first synchronizer ring which cooperates via a first friction surface with a corresponding first mating surface of a first clutch body, the first clutch body connected in a rotationally fixed manner to the rotatably mounted first transmission element or the at least one transmission element, and/or the at least one braking device includes at least one second synchronizer ring, the at least one second synchronizer ring cooperates via a second friction surface with a corresponding second mating surface of a second clutch body, the second clutch body connected in a rotationally fixed manner to a rotatably mounted second transmission element of the at least one rotatably mounted transmission element;
wherein a synchronizer body which is connected in a rotationally fixed manner to the housing via the sliding sleeve is arranged adjacent to the first clutch body or the second clutch body, and wherein the synchronizer body is rotatably mounted.

2. The gear shifting device of claim 1, wherein, in the first shift position the rotatably mounted second transmission element is separated from the at least one transmission element fixed to the housing, and in the second shift position the second transmission element is connected in a rotationally fixed manner to the at least one transmission element.

3. The gear shifting device of claim 2, wherein between the first and the second shift position of the sliding sleeve a neutral position is formed in which neither the rotatably mounted first transmission element nor the rotatably mounted second transmission element is braked or held.

4. The gear shifting device of claim 2, wherein the sliding sleeve is configured and arranged to be rotatably connected via at least one braking device to the rotatably mounted first transmission element, or the rotatably mounted second transmission element and the transmission element fixed to the housing.

5. The gear shifting device of claim 1, wherein the first friction surface and/or the second friction surface are/is conical.

6. The gear shifting device of claim 1, wherein the second clutch body is rotatably mounted on the rotatably mounted first transmission element or on the transmission element fixed to the housing.

7. The gear shifting device of claim 1, wherein the sliding sleeve is connected to the synchronizer body in an axially displaceable manner.

8. The gear shifting device of claim 1, wherein the synchronizer body is arranged between the first clutch body and the second clutch body.

9. The gear shifting device of claim 1, wherein the braking device and the transmission are configured and arranged as a unit.

10. The gear shifting device of claim 1, wherein the transmission element fixed to the housing is formed integrally with a housing of the transmission.

11. The gear shifting device of claim 1, wherein the synchronizer body is rotatably mounted on the first transmission element, the second transmission element, or a separate shaft.

12. Planetary transmission comprising:
at least one rotatably mounted first transmission element;
at least one rotatably mounted second transmission element;
at least one third transmission element selected from the group consisting of: sun gear, planet carrier and ring gear; and
a shift device including at least one braking device configured and arranged for holding at least one transmission element according to claim 1.

13. The planetary transmission of claim 12, wherein the planetary transmission is a Ravigneaux planetary transmission, the planetary transmission including a first sun gear, a second sun gear, and a first planetary gear set with a planet carrier with a first planetary gear set including first planet gears and a second planetary gear set including second planet gears, and a ring gear;
wherein the first sun gear is configured and arranged in meshing engagement with the first planet gears, the first planet gears configured and arranged in meshing engagement with second planet gears, and the second planet gears are configured and arranged in meshing engagement with the second sun gear and the ring gear.

14. The planetary transmission of claim 13, wherein the rotatably mounted first transmission element is sun gear, and the rotatably mounted second transmission element is formed by the planet carrier.

15. The planetary transmission of claim 13, wherein the second sun gear has a larger diameter than the first sun gear.

16. A vehicle transmission arrangement comprising: a planetary transmission according to claim 12.

17. The planetary transmission of claim 14, wherein the rotatably mounted first transmission element is the second sun gear.

18. The gear shifting device of claim 9, wherein the braking device is integrated into the transmission.
